(19) United States
(12) Patent Application Publication
(10) Pub. No.: US 2020/0099914 A1
(43) Pub. Date: Mar. 26, 2020

(54) STEREO IMAGING DEVICE

(71) Applicant: MAXELL, LTD., Otokuni-gun, Kyoto (JP)

(72) Inventor: Hiroyasu OTSUBO, Otokuni-gun (JP)

(73) Assignee: MAXELL, LTD., Otokuni-gun, Kyoto (JP)

(21) Appl. No.: 16/618,194

(22) PCT Filed: May 24, 2018
(86) PCT No.: PCT/JP2018/019950

§ 371 Date: Nov. 29, 2019

(30) Foreign Application Priority Data
Jun. 1, 2017 (JP) 2017-109413

(51) Int. Cl. H04N 13/167; H04N 5/232; G03B 35/08

(52) U.S. Cl. CPC H04N 13/167; G03B 35/08; H04N 5/23227

(57) ABSTRACT

A stereo imaging device includes a first image sensor and a second image sensor each capable of outputting a captured image signal. A monitoring signal and a parallax detection signal generating unit and a parallax detection signal generating unit are operated to generate two parallax detection signals for detecting a parallax from the two image signals of the two image sensors also generate, from an image signal fed from one of the two image sensors, a monitoring signal to be outputted to the monitor. The first reduction processing circuit reduces and outputs a monitoring signal at a preset reducing rate. The second reduction processing circuit performs a conversion on an arbitrary range of an image indicated by the parallax detection signal, so as to form an arbitrary reduction ratio, thus outputting a parallax detection signal.

### TECHNICAL FIELD

The present invention relates to a stereo imaging device that can be used as a stereo camera for outputting an image for use in monitoring and for outputting an image for detecting a parallax.

### BACKGROUND ART

Generally, a surveillance camera captures an image and displays the image on a monitor, and this image is used by a person for monitoring the image in real time or storing the image to confirm an incident after the incident occurs. In recent years, with the development of AI (Artificial Intelligence) technology, it is possible to automatically detect the presence of a specific person or automatically detect the intrusion of a suspicious person into a restricted area by recognizing the image.

On the other hand, it has been proposed to use a stereo camera for performing a stereoscopic photographing, such as for calculating a distance from a parallax on the images of the two cameras constituting the stereo camera to an object, and for using such a distance in monitoring (Patent Document 1). Since it is possible to calculate a three-dimensional structure of an object by using two images of the stereo camera as images for image recognition, it is possible to improve the precision of image recognition.

### CITATION LIST

Patent Document
Patent Document 1: JP 2013-109779A

### SUMMARY OF THE INVENTION

### Technical Problems

On the other hand, in a digital camera, the number of pixels of an image sensor in use tends to increase, and a camera has been known that captures a so-called 4K moving image or 8K moving image having larger number of pixels than so-called full high-definition moving image. Even in a surveillance camera, the number of pixels of an image sensor tends to increase, and there is a need to use an image sensor with a large number of pixels. However, a monitor for use in monitoring is usually a monitor having a resolution lower than that of full high-definition monitor, and it is impossible to display a moving image of 4K or more on a normal monitor.

In image recognition, an arithmetic processing for image recognition is performed by an integrated circuit. However, it is difficult to process an output from an image sensor having a high pixel count, in view of cost, processing capability, and data transfer speed, and it is necessary to lower a frame rate on processing. In this case, if the frame rate of a moving image outputted from the image sensor to the monitor is reduced in the same manner as the output to the integrated circuit for image recognition, the frame rate will be too low and the moving image becomes difficult to view.

In addition, it is conceivable to reduce both an image for monitoring and an image for recognition. However, when the image data simply reduced is used in both monitor output and image recognition, it is not meaningful to use an image sensor with a high pixel count.

The present invention has been accomplished in view of the above problems, and it is an object of the present invention to provide a stereo imaging device which can output a moving image with a number of pixels according to a monitor for monitoring, and can separately output a moving image having a number of pixels and a frame rate that can perform an image recognition with an amount of calculation according to the limit of an integrated circuit (arithmetic device) based on a cost or the like.

### Solution to the Problems

In order to solve the aforementioned problems, an improved stereo imaging device is provided that outputs image signals captured by a stereo camera to a monitoring monitor and outputs the image signals to an image recognition unit that generates at least a distance image from a parallax of the image signals, the stereo imaging device comprising:

two image sensors for outputting the image signals;

parallax detection signal generating unit for generating two parallax detection signals for detecting a parallax from the two image signals;

monitoring signal generating unit for generating a monitoring signal to be outputted to the monitor, from an image signal fed from one of the two image sensors;

parallax detection signal reducing unit for reducing and outputting the parallax detection signals; and

monitoring signal reducing unit for reducing and outputting the monitoring signal.

According to such a configuration, the monitoring signal outputted to the monitor from the stereo imaging device which is a stereo camera, and the two right and left parallax detection signals are outputted. Therefore, it is possible to perform both monitoring and image recognition using a distance image, by connecting an arithmetic device (for generating distance image based on parallax detection and for performing image recognition) to a monitor of the stereo imaging device.

At this time, since the monitoring signal and the parallax detection signal can be reduced respectively, it is possible to output the monitoring signal at a reduction rate according to the monitor, and output the parallax detection signal at a reduction rate and a frame rate according to the processing capability of the arithmetic device that performs image recognition and the like. Further, in the parallax detection, even if the frame rate or the image reduction rate changes, the frame rate and the reduction rate do not change on the monitor side, so that the monitoring is not hindered.

According to the above configuration of the present invention, the parallax detection signal generating unit and the monitoring signal generating unit include two or more line memories, and perform a synchronization processing on the monitoring signal, and perform a smoothing processing on the parallax detection signals by using the line memories.

Using the above configuration, it is possible to reduce the cost of a stereo imaging device.

According to the above configuration of the present invention, each of the parallax detection signal reducing unit and the monitoring signal reducing unit includes a plurality of line memories, and performs sub-sampling using the line memories.

Using the above configuration, it is possible to reduce the cost of a stereo imaging device.

According to the above configuration of the present invention, the parallax detection signal generating unit and the monitoring signal generating unit include frame memory, and perform a synchronization processing on the monitoring signal, and perform a smoothing processing on the parallax detection signals by using the frame memory.

Using the above configuration, it is possible to easily generate a monitoring signal and a parallax detection signal.

According to the above configuration of the present invention, each of the parallax detection signal reducing unit and the monitoring signal reducing unit includes frame memory, and reduces the parallax detection signals and the monitoring signal by using the frame memory.

Using the above configuration, it is possible to reduce a monitoring signal and a parallax detection signal.

According to the above configuration of the present invention, the parallax detection signal reducing unit is configured to cut out an image represented by a parallax detection signal, in a manner such that the image becomes smaller than its original size, thereby outputting the parallax detection signal in which the pixels of the image have been reduced.

According to such a configuration, when outputting the parallax detection signal, it is possible to change the data amount of image signal not only by adjusting the reduction rate, but also by changing a range of image cutting-out. For example, when a human face is detected on a reduced image, it is possible to collate the stored data of human face using a high-definition face image, without reducing this portion of the image but only performing the cutting out. In this way, it is possible to effectively use the data of high-definition image sensor.

### Effects of the Invention

According to the present invention, it is possible to output from the stereo camera, at different reduction rates, a monitoring signal and a parallax detection signal for image recognition using a parallax.

### BRIEF DESCRIPTION OF THE DRAWINGS

FIG. 1 is a block diagram showing a stereo imaging device according to an embodiment of the present invention.

FIG. 2 is a diagram showing an array of color filters of an image sensor of the stereo imaging device.

FIG. 3 is a block diagram showing a monitoring signal and a parallax detection signal generating unit.

FIG. 4 is a block diagram showing a line memory unit.

FIG. 5 is a block diagram showing a color synchronization processing circuit.

FIG. 6 is a block diagram showing a vertical synchronization circuit.

FIG. 7 is a block diagram showing a horizontal synchronization circuit.

FIG. 8 is a block diagram showing a color/luminance processing circuit.

FIG. 9(a) is a diagram showing a formula for color matrix processing and an example of matrix A in the formula.

FIG. 9(b) is a diagram showing a formula for luminance matrix processing and an example of matrix B in the formula.

FIG. 9(c) is a diagram showing a formula for a white balance processing.

FIG. 10 is a block diagram showing a vertical filtering processing circuit.

FIG. 11 is a block diagram showing a horizontal filtering processing circuit.

FIG. 12 is a block diagram showing a first reduction processing circuit.

FIG. 13 is a block diagram showing a second reduction processing circuit.

FIG. 14 is a block diagram showing a second reduction processing circuit.

FIG. 15 is a diagram for explaining the outputs of a monitoring signal and a parallax detection signal.

FIG. 16 is a diagram for explaining the outputs of a monitoring signal and a parallax detection signal.

### DESCRIPTION OF EMBODIMENTS

Hereinafter, embodiments of the present invention will be described in detail.

The stereo imaging device according to the present embodiment uses, for example, a stereo camera as a camera mainly for monitoring, such as a monitoring camera and an in-vehicle camera. The stereo imaging device is not for outputting a stereoscopic image, but for outputting an image for use in monitoring and for outputting two images for use in detecting a parallax. In the stereo imaging device of the present embodiment, what is used is, for example, one of two images of a stereo camera for monitoring, thereby outputting two-dimensional color image. Also, the two images are outputted as parallax detection images in grayscale. The parallax detection image is an image for calculating a distance image indicating a distance between the pixels, by obtaining a parallax between the two images.

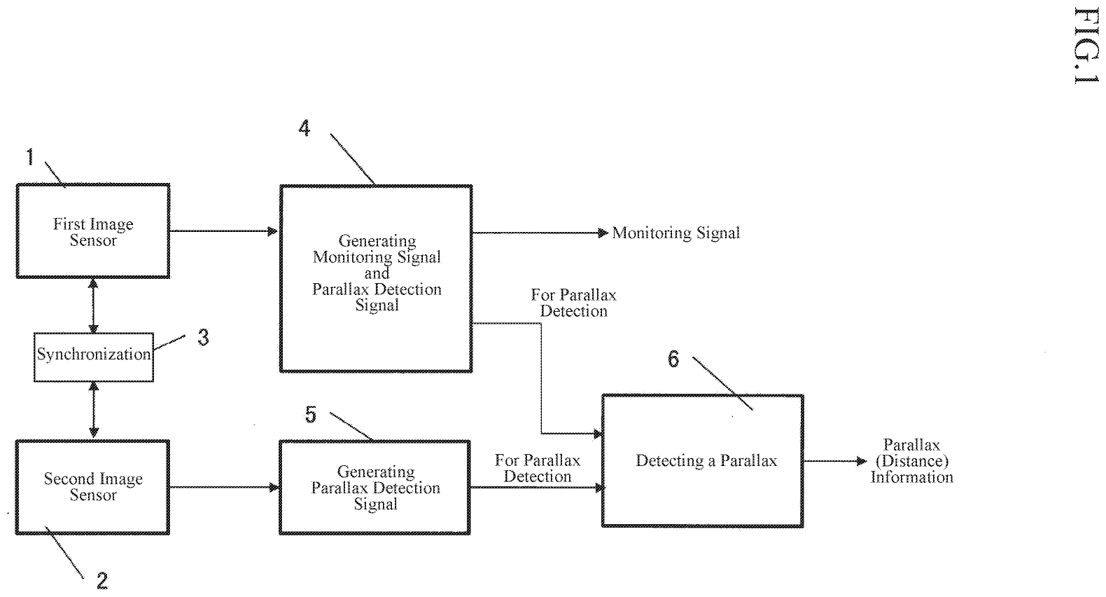

As shown in FIG. 1, the stereo imaging device according to the present embodiment includes: a first image sensor 1 and a second image sensor 2 which are both imaging units; synchronization unit 3 for synchronizing the first image sensor 1 and the second image sensor 2; monitoring signal and parallax detection signal generating unit 4 which, when the output signal of the first image sensor 1 has been inputted thereinto, outputs a monitoring signal that is an image signal for monitoring, also outputs one of the left and right parallax detection signal; parallax detection signal generating unit 5 for outputting the other parallax detection signal; parallax detecting unit 6 which performs parallax detection from the left and right parallax detection signals, and outputs a distance image at which each pixel is indicated by distance. On the other hand, the parallax detecting unit 6 may be contained in the stereo imaging device or may be connected to the stereo imaging device outside the stereo imaging device.

The first and second image sensors 1, 2 and the synchronization unit 3 together constitute a stereo camera, thus outputting a pair of image (moving image) data synchronized on the left and right. Further, the first image sensor 1 and the second image sensor 2 of the stereo camera are capable of photographing with a visible light and photographing with a near infrared light, and may be image sensors using a double bandpass filter (DBPF) in place of an infrared cutting filter which is usually employed in a normal camera. However, it is also possible to use an infrared cutting filter to capture only a visible light.

The first and second image sensors 1, 2 include DBPFs and color filters, serving as cameras for capturing a visible image and an infrared image. The DBPF is configured to transmit a light in a visible light band and a light in a near infrared light band. The color filter is formed by making a mosaic pattern on a white W pixel area which transmits substantially all of infrared IR lights and visible lights, in addition to pixel areas of red R, green G and blue B.

The DBPF is an optical filter having a transmission characteristic in a visible light band, and having a blocking characteristic in the first wavelength band adjacent to the long wavelength side of the visible light band, and also having a transmission characteristic in a second wavelength band that is a part of the first wavelength band. A wavelength band (a part of the first wavelength band) between the visible light band and the second wavelength band has a blocking characteristic with respect to light. Since the stereo camera of the present embodiment does not use an infrared cutting filter which is usually employed in a normal camera, it is possible for DBPF to transmit an infrared light (second wavelength band), and also possible for a color filter to transmit a light in white W pixel region. In such case, the infrared light not only transmits through the white W pixel region of a dichroic color filter, but also transmits through the R, G, and B pixel regions. That is, the color filter has a characteristic of transmitting an infrared light, while an ordinary camera uses an infrared cutting filter to eliminate the influence from an infrared light.

In this embodiment, for example, a visible light image and an infrared light image can be finally obtained by calculation. On the other hand, the above-described white W pixel region of the color filter is not a white region, but is a colorless and transparent region that transmits visible light and infrared light.

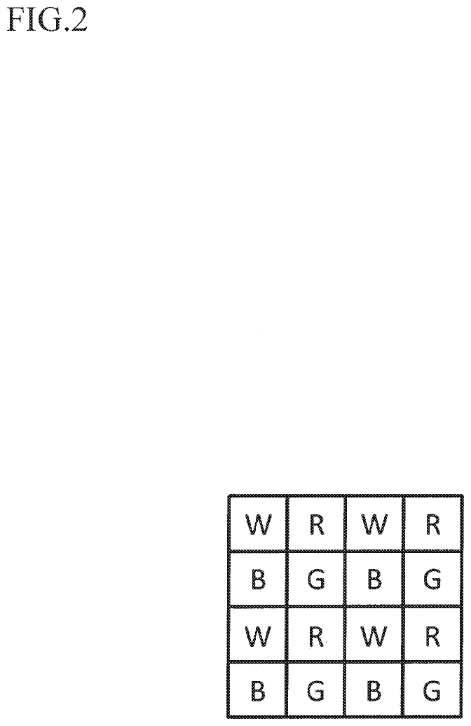

FIG. 2 shows a basic array of pixel areas of various colors in the color filter of the first and second image sensors. Here, the color filter has a pattern in which the basic array is repeatedly arranged. On the other hand, the array of a color filter should not be limited to that shown in FIG. 2.

A signal corresponding to the color filter is outputted from the first and second image sensors 1, 2. The output image signal is outputted from the first image sensor 1 to the monitoring signal and parallax detection signal generating unit 4 and sent from the second image sensor 2 to the parallax detection signal generating unit 5.

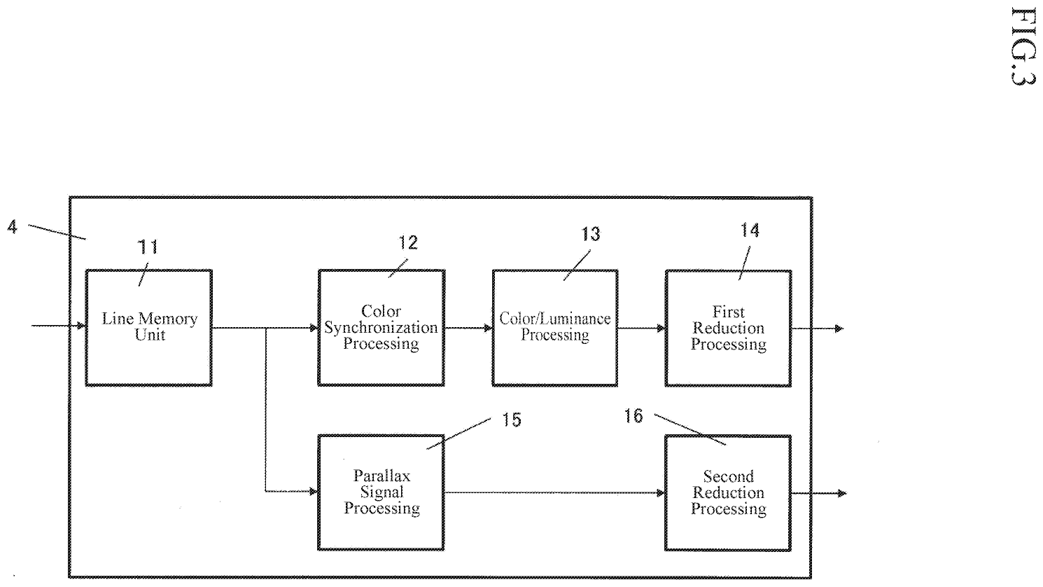

As shown in FIG. 3, the monitoring signal and parallax detection signal generating unit 4 includes a line memory unit 11 and generates a monitoring signal and one parallax detection signal using a plurality of line memories (to be described later). In the generation of the monitoring signal, color synchronization processing (color synchronization processing circuit 12) is performed on the output signal fed from the first image sensor 1. Namely, interpolation is performed by interpolation processing. Thus, it is possible to create an image in which all pixels are in red R regions (frames), an image in which all pixels are in green G regions (frames), an image in which all pixels are in blue B regions (frames), and an image in which all pixels are in white W (infrared IR) regions.

In the monitoring signal generation, for example, color/luminance processing (color/luminance processing circuit 13) for converting RGB signals into luminance and color difference (for example, Y, Cb, Cr) signals is performed, followed by the first reduction processing (using the first reduction processing circuit 14 (monitoring signal reduction unit)). In addition, since the parallax detection signal generation does not need colors in calculating a parallax, parallax detection signal processing (parallax detection signal processing circuit 15) is performed which generates, as parallax detection signal, so-called grayscale (luminance signal) image signal obtained by smoothing RGBW using line memory without synchronization, followed by the second reduction processing (second reduction processing circuit 16 (parallax detection signal reduction unit)).

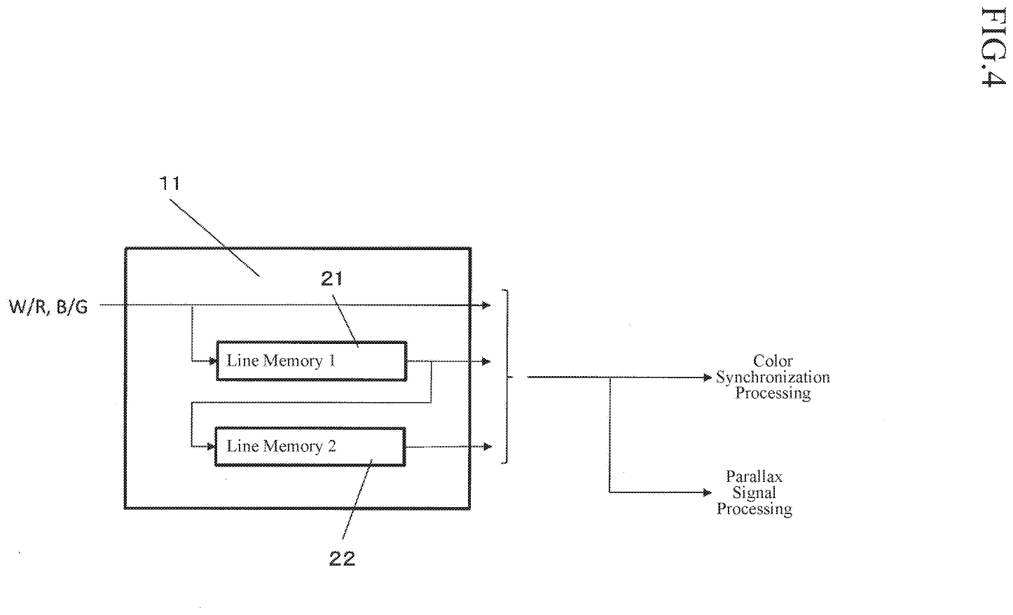

As shown in FIG. 4, in the above-described line memory unit 11, for example, RGBW signals outputted from the first image sensor 1 using the two line memories 21, 22 is divided into three phases from a through output signal, an output of the first line memory 21 and an output of the second line memory 22, and then outputted. Signal output from the first pixel sensor 1, based on the array of the color filter shown in FIG. 2, is in a state in which signals of WRWRWR . . . having white W and red R alternated and signals of GBGBGB . . . having green G and blue B alternated are repeated. Then, a monitoring signal and a parallax detection signal are generated using signals from the through output signal and signals from the line memories 21, 22.

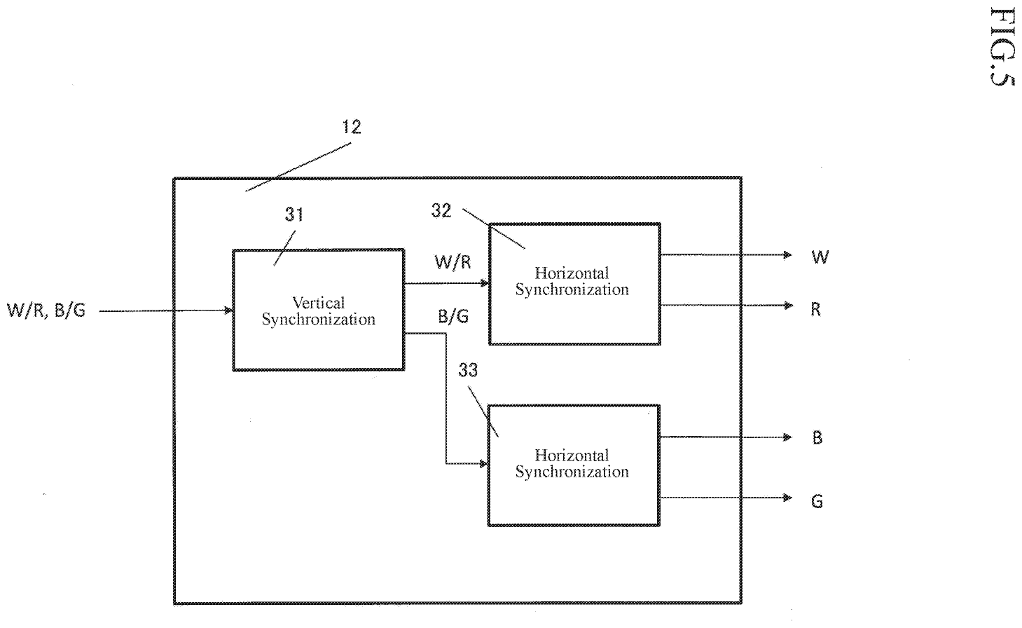

As shown in FIG. 5, the color synchronization processing circuit 12 includes a vertical synchronization circuit 31 in the vertical direction of an image and two horizontal synchronization circuits 32, 33 in the horizontal direction of an image. In the vertical synchronization circuit 31, a signal in which WRWRWR . . . and BGBGBBG . . . are repeated in a horizontal scan using the above-described color filter array is used as a signal of WRWRWR . . . only and a signal of BGBGBBG . . . only.

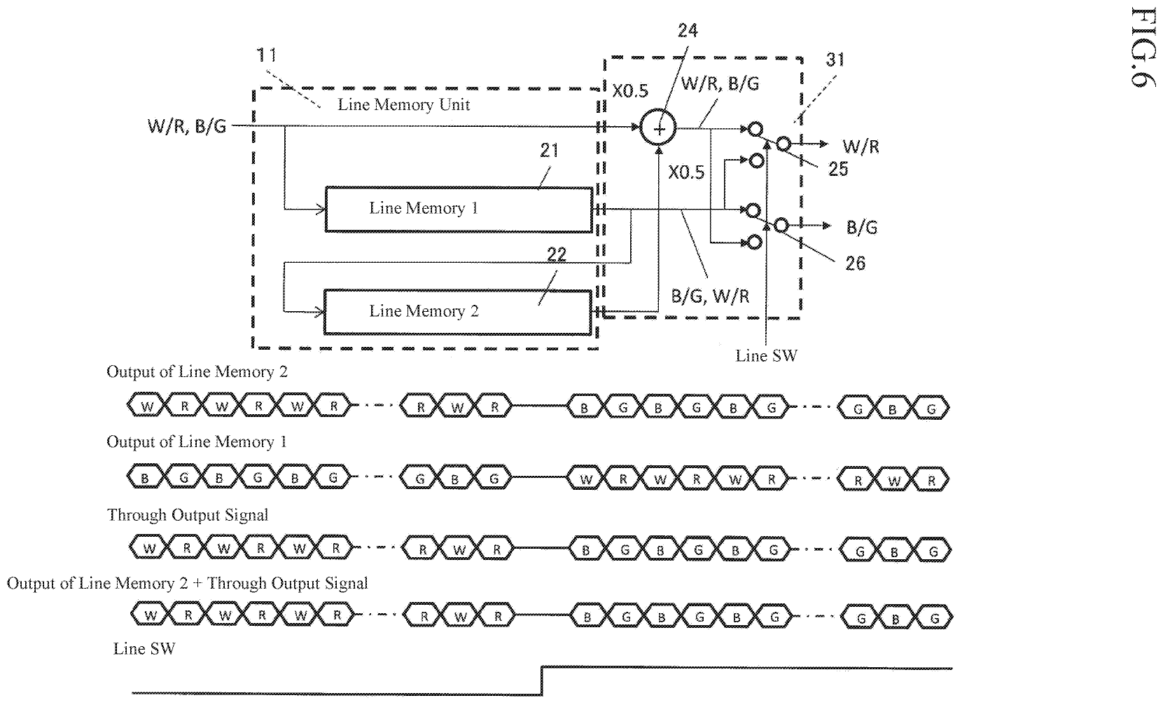

Namely, as shown in FIG. 6, in the vertical synchronization circuit 31 of the color synchronization processing circuit 12, two line memories 21, 22, addition processing unit 24 and two line changeover switches 25, 26 are used to perform vertical synchronization processing, to process an output signal fed from the first image sensor 1 (second image sensor 2). In the pixel array shown in FIG. 2, an output from the first image sensor 1 is, for example, in a state where after an output of one line of WRWRWRWR . . . serving as an output of one column of pixels in the horizontal direction, an output of another line of BGBGBGBG . . . of the next column of pixels will be repeated, thus forming a through output signal fed from the first image sensor 1.

On the other hand, in the first line memory 21, since the output of the above one line is first stored and then outputted, the output will be delayed by one line with respect to the through output signal. Further, in the second line memory 22, since the output of one line of the first line memory 21 is first stored and then outputted, the output will be delayed by two lines with respect to the through signal. When this is considered with reference to the output of the first line memory 21, the through output signal will be earlier by one line than the output of the first line memory 21, and the output of the second line memory 22 will be delayed by one line.

Also, the output of one line is only the outputs of white W and red R, or only the outputs of green G and blue B. In this case, when the output of the first line memory 21 is used as a reference, if the output of the first line memory 21 is green G and blue B, the through output signal and the output of the second line memory 22 will be white W and red R. On the other hand, when the output of the first line memory 21 is white W and red R, the through output signal and the output of the second line memory 22 will be green G and blue B. Therefore, an output signal of only white W and red R and an output signal of only green G and blue B are outputted simultaneously, by combining the output of the first line memory 21 with the outputs of the through output signal and second line memories 22.

As shown in FIG. 6, ½ of the through output signal and ½ of the output of the second line memory 22 are added together by the addition processing unit 24, thereby generating an output of white W and red R, or an output of green G and blue B. Namely, in a matrix-like pixel group in both the horizontal direction and the vertical direction, an output that is an average of an output of the pixels in the horizontal column above a reference pixel column and an output of the pixels in the horizontal column below the reference pixel column, is combined into the output signals of pixels of one horizontal column serving as a reference.

For each output of one line, the outputs of the first line memory 21, the second line memory 22 and the through output signal are changed-over between the output of white W and red R and the output of green G and blue B. Meanwhile, with respect to the output of the first line memory 21, the outputs of the through output signal and second line memory 22 are always reversed between the output of white W and red R and the output of green G and blue B.

Therefore, the output of the first line memory 21 is changed-over between the output of white W and red R and the output of green G and blue B, while the output of the addition processing unit 24 is changed-over between the output of green G and blue B and the output of white W and red R. Accordingly, using the line changeover switches 25, 26, a change-over can be performed between the output of the first line memory 21 and the output of the addition processing unit 24, with one terminal constantly outputting white W and red R signals during photographing, and the other terminal constantly outputting green G and blue B signals during photographing, thereby ensuring that the vertical synchronization process has been performed.

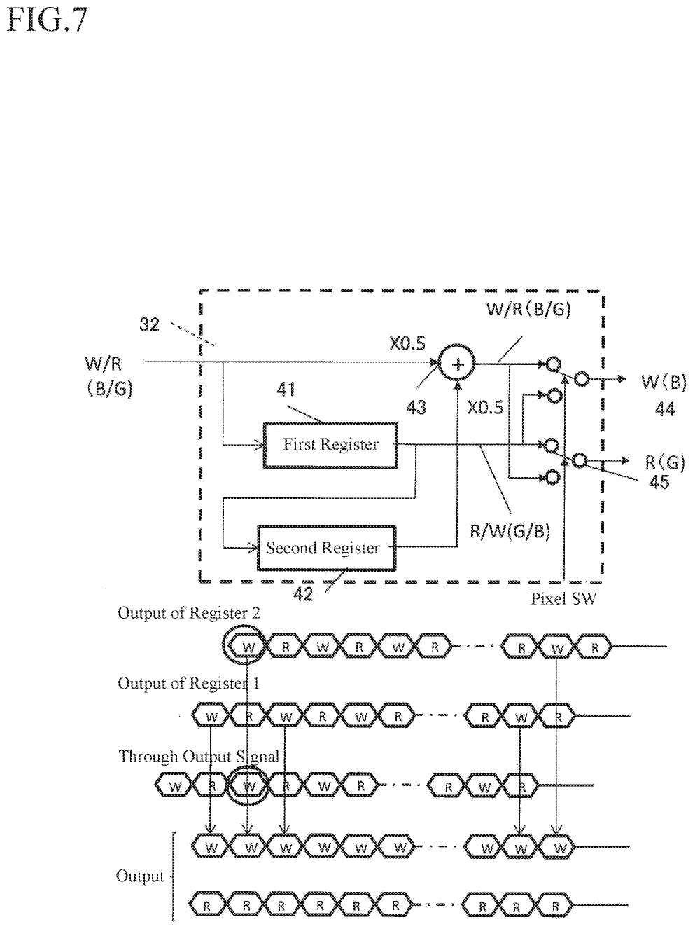

WRWRWR . . . signals and BGBGBG . . . signals generated as described above are sent to the horizontal synchronization circuits 32, 33. Next, in the horizontal synchronization circuit 32 shown in FIG. 7, the horizontal synchronization processing is performed. The horizontal synchronization circuit 32 performs horizontal synchronization processing, using a first register 41, a second register 42, a pixel addition processing unit 43, and pixel changeover switches 44, 45. Although the horizontal synchronization circuit 32 is shown in FIG. 7, the horizontal synchronization circuit 33 has the same configuration. In this embodiment, the horizontal synchronization circuit 32 processes the WRWRWR . . . signals, while the horizontal synchronization circuit 33 processes the BGBGBG . . . signals.

Here, description will be given to the horizontal synchronization processing on the outputs of white W and red R. At first, the through output signal is a signal in which white W and red R are repeated. The output of the first register 41 stores the output of one pixel of the through output signal and then outputs the same, and the output will be delayed by one pixel with respect to the output of through output signal. The output of the second register 42 is produced after the output of the first register 41 is stored for one pixel, and is delayed by one pixel with respect to the output of the first register 41.

Therefore, with respect to the output of the first register 41, the through output signal is accelerated by one pixel, and the output of the second register 42 is delayed by one pixel. Here, when the outputs of white W and red R are changed-over for each pixel, if the output of the first register 41 is white W, the outputs of the through output signal and second register 42 will be red R. On the other hand, if the output of the first register 41 is red R, the outputs of the through output signal and the second register 42 will become white W. Accordingly, by combining the output of the first register 41 with the outputs of the through output signal and second register 42, it is possible to obtain both outputs of white W and red R for one pixel. Here, ½ of the through output signal and ½ of the signal output of the second register 42 are added in the pixel addition processing unit 43 and then outputted. This output is an average of an output of a pixel immediately before a pixel having the output of the first register 41 and an output of a pixel immediately after the pixel having the output of the first register 41.

The output of the first register 41 is changed over between white W and red R for each pixel, and the output of the pixel addition processing unit 43 is changed over between red R and white W for each pixel. Using pixel changeover switches 44, 45, changeover is performed between the output of the first register 41 and the output of the pixel addition processing unit 43 for each pixel. In this way, white W is constantly outputted from the white W terminal during photographing, while red R is constantly outputted from the red R terminal during photographing. Further, Green G and blue B are similarly processed. As a result, the output from the color synchronization processing circuit 12 will produce four signals of white W, red R, green G, and blue B for each pixel, resulting in four images of red, green, blue, and white.

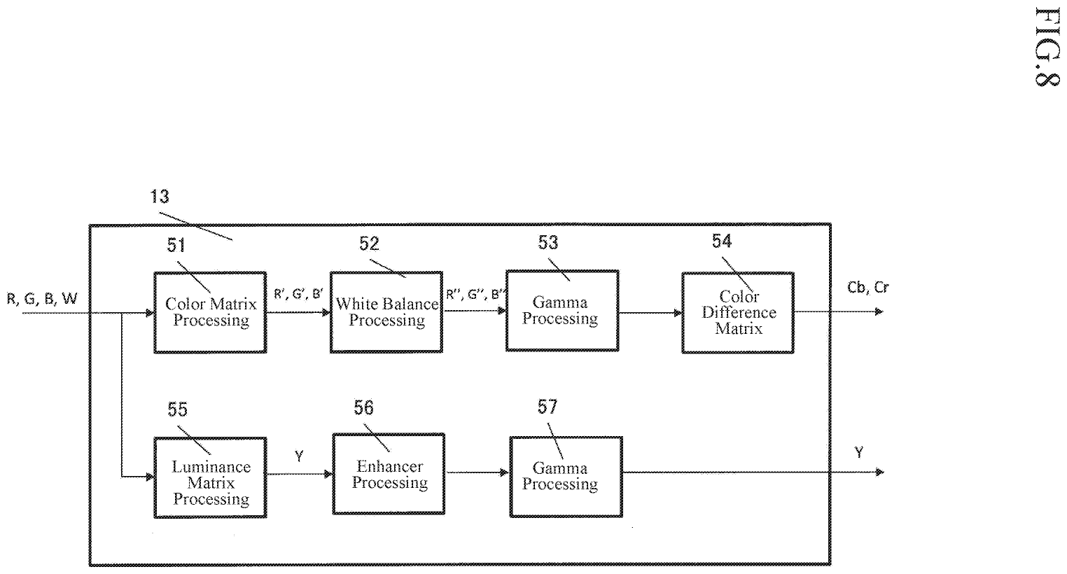

RGBW signals processed in the synchronization are sent to the color/luminance processing circuit 13 shown in FIG. 8. Then, in order to generate color difference signals, Cb and Cr are outputted through color matrix processing 51, white balance processing 52, gamma processing 53, color difference matrix processing 54. Further, Y luminance signal is outputted through the luminance matrix processing 55, the enhancer processing 56, and the gamma processing 57.

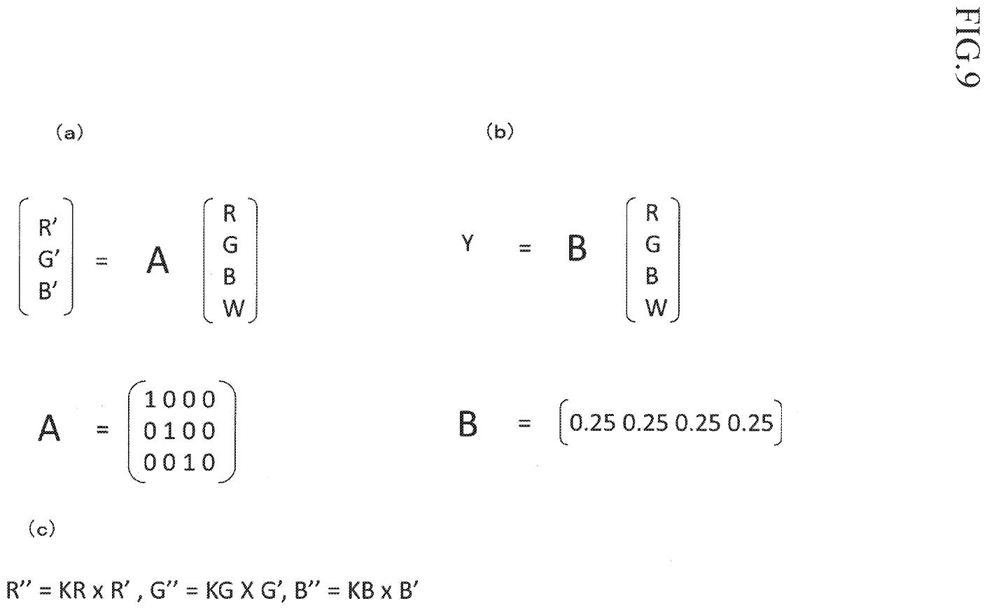

FIG. 9(a) shows a formula of color matrix processing for converting RGBW signals processed in the synchronization processing into RGB signals R′G′B′. FIG. 9(b) shows a formula of luminance matrix processing for converting RGBW signals processed in the synchronization processing into luminance signal, also shows an example of B matrix in the formula. FIG. 9(c) shows a formula of white balance processing for obtaining a white balance from RGB signals R′G′B′ obtained in the color matrix processing 51. Here, white balance correction coefficient KR is a correction coefficient for R information of captured image, white balance correction coefficient KG is a correction coefficient for G information of captured image, and white balance correction coefficient KB is a correction coefficient for B information of captured image.

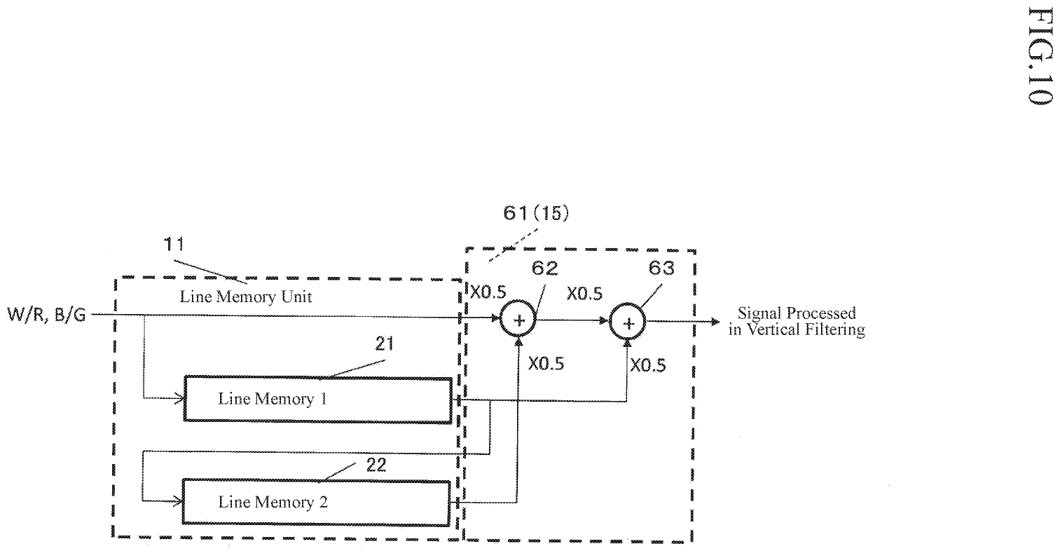

In addition, signals of three different phases outputted from the line memory unit 11 are sent to the parallax detection signal processing circuit 15 and converted into parallax detection signals for use in parallax detection. Since the parallax detection signal processing circuit 15 does not require colors, the above signals are smoothed and converted to a gray scale (luminance signal). In the parallax detection signal processing circuit 15, a vertical filtering processing (vertical filtering processing circuit 61) is performed. As shown in FIG. 10, the vertical filtering processing circuit 61 includes two addition processing units 62, 63, and adds WRWRWR . . . and BGBGBG . . . into a signal in which WRWRWR . . . and BGBGBG . . . are changed-over for each line, thereby creating smoothed signals. In smoothing, as in the case of the synchronization process in the vertical direction, with the output of the first line memory 21 serving as a reference, the through output signal and the signal of the second line memory 22 are halved respectively, and then added together in the addition processing unit 62. Subsequently, ½ of the sum of the through output signal and the signal of the second line memory 22 and ½ of the signal of the first line memory 21 are added together, rendering it possible to smoothen (in the vertical direction) a signal which is changed-over for each line.

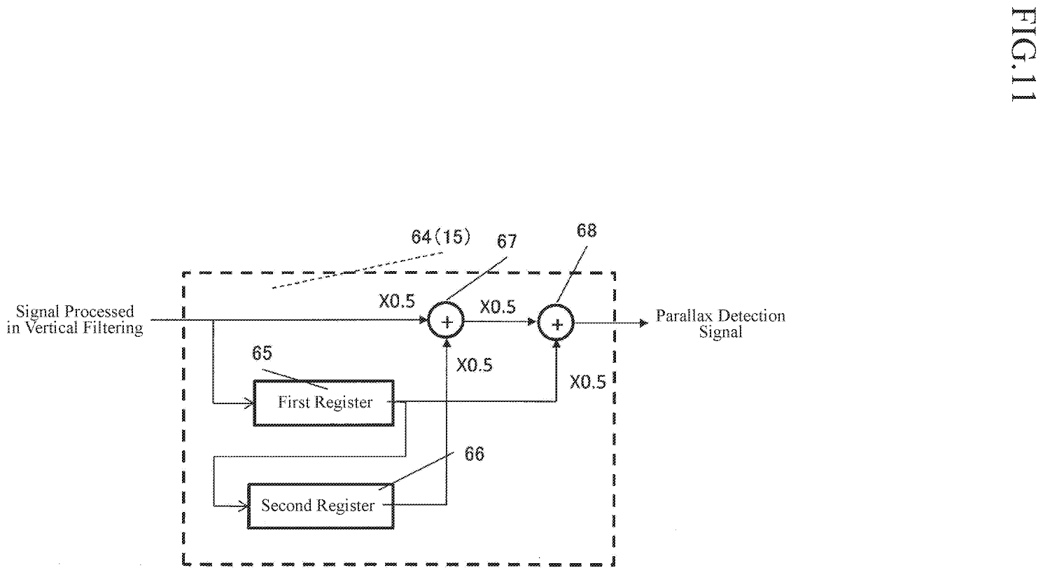

Next, as shown in FIG. 11, in the parallax detection signal processing circuit 15, after the vertical filtering process is performed, the horizontal filtering processing (horizontal filtering processing circuit 64) is performed. Similar to the horizontal synchronization circuit 32, the horizontal filtering processing circuit 64 includes a first register 65, a second register 66 and also includes two addition processing units 67, 68. In the horizontal filtering processing circuit 64, the through output signal is inputted into and outputted from the first register 65 for each pixel at one time, so that the signal will be delayed by only one pixel. Further, since the signal of the first register 65 is inputted into and outputted from the second register 66 by one pixel at one time, the signal will be further delayed by only one pixel. In the horizontal filtering processing circuit 64, since a signal is outputted which has been processed in the vertical filtering processing circuit 61 in which R+G and W+B are alternately arranged, it is possible to use the signal of the first register 65 as a reference, to add together ½ of the through signal and ½ of the signal of the second register 66 in an addition processing unit 67 so as to obtain a sum signal. Subsequently, ½ of this signal and ½ of the signal of the first register 65 are added together in the addition processing unit 68 to obtain a horizontal filtering signal. Namely, WRGB are added together in each pixel to obtain a smoothed signal which will be used in parallax detection.

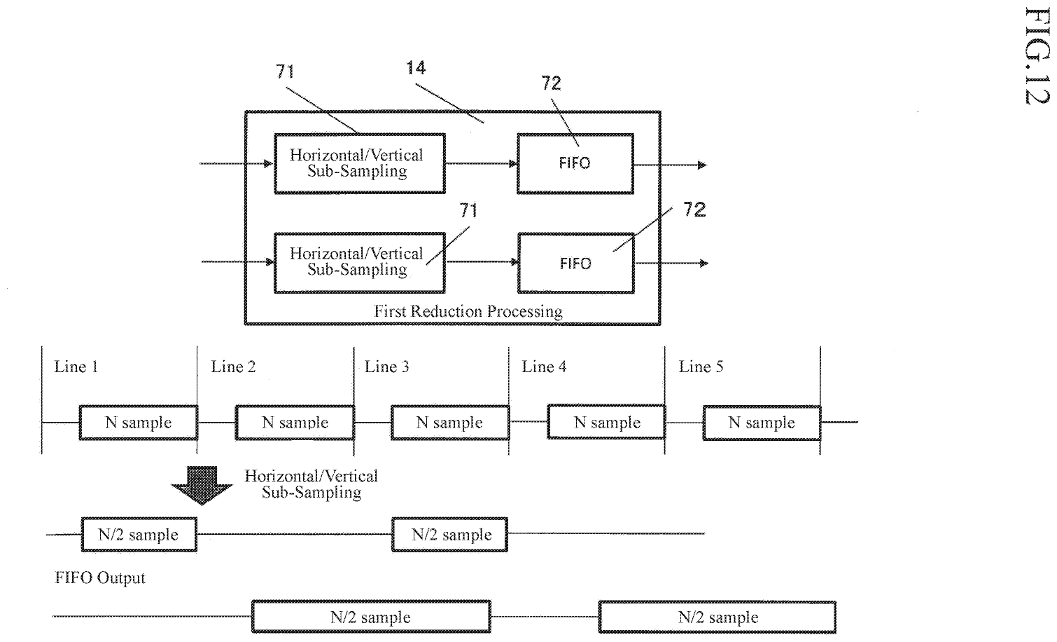

The monitoring signal and the parallax detection signal are outputted in a decimation-processed and reduced state. In this embodiment, as shown in FIGS. 12-14, decimation (decimating) is performed on the monitoring signal using the first reduction processing circuit 14, and decimation is also performed on the parallax detection signal using the second reduction processing circuit 16.

In the first reduction processing circuit 14 for the monitoring signal, a signal converted into the luminance signal described above is inputted. In fact, the first reduction processing circuit 14 includes a circuit in which the luminance is decimated and another circuit in which a signal converted into a color difference signal is inputted and the color difference is then decimated. For example, luminance signals and color difference signals are subsampled and reduced when they are inputted into line memory, stored there and outputted therefrom. In the first reduction processing circuit 14, particularly in the horizontal/vertical sub-sampling circuit 71 having line memory, for example, sub-sampling is performed that halves the number of samples N both in the horizontal direction and in the vertical direction, thereby reducing the number of samples. Then, with the number of samples reduced, the number of samples is stored in the FIFO circuit 72 and is slowly outputted from the FIFO circuit 72. During the subsampling, for example, the number of samples per line is reduced, and the number of lines is also reduced, and subsampling is performed in both the horizontal and vertical directions.

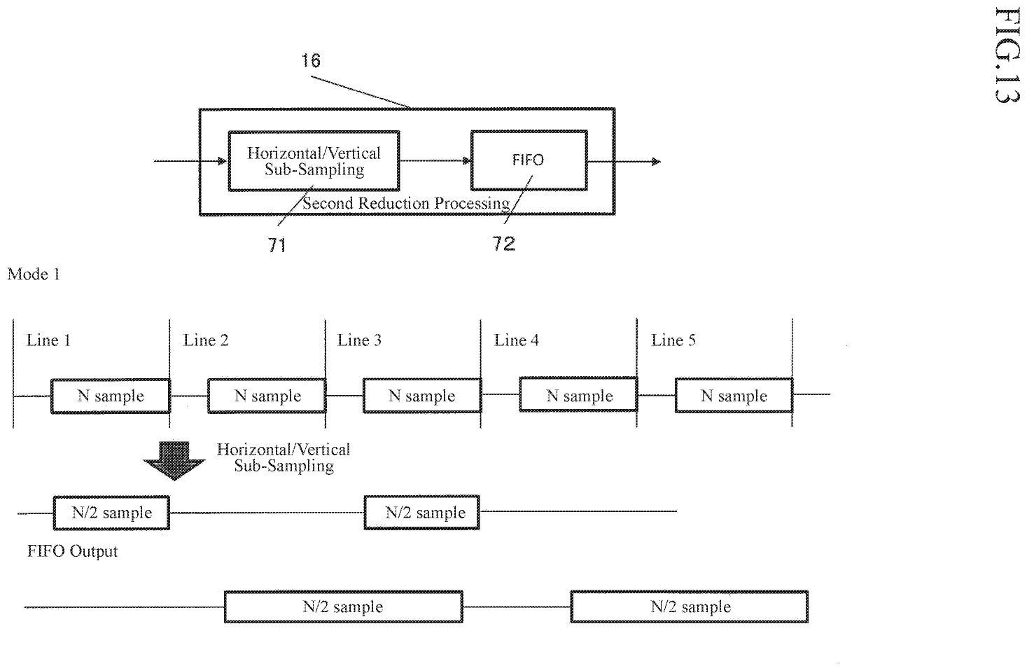

In addition, as shown in FIG. 13, regarding the parallax detection signal, the luminance signal smoothed as described above is inputted into the second reduction processing circuit 16. Then, similar to a monitoring signal, in the horizontal/vertical sub-sampling circuit 71, sub-sampling is performed to halve the number of samples N in both the vertical direction and the horizontal direction, while the sub-sampled data is outputted from the FIFO circuit 72.

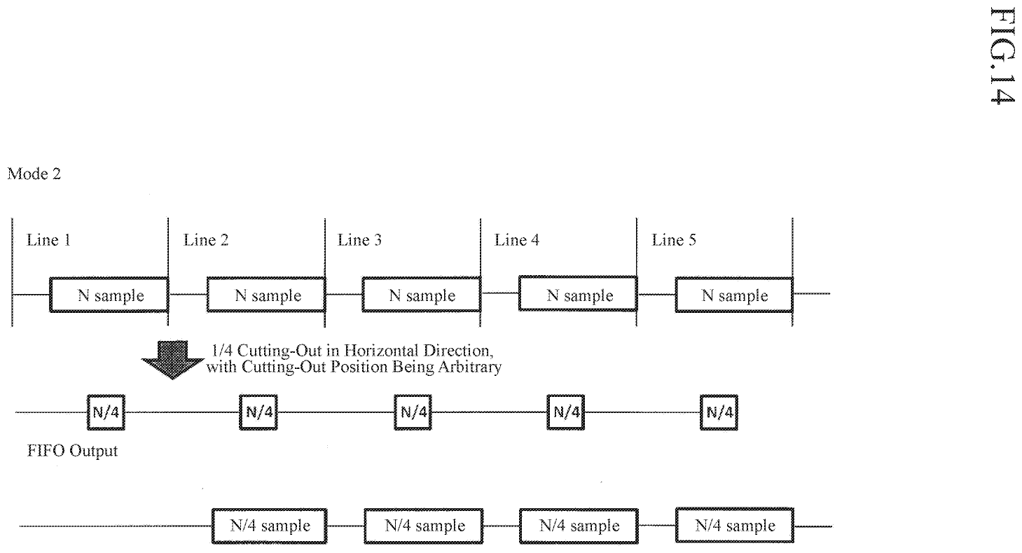

As shown in FIG. 14, in the present embodiment, the second reduction processing circuit 16 cuts out a part of the image data rather than reducing the same.

Here, image area is reduced by reducing the number of vertical and horizontal pixels by ½ at the time of reduction. However, in the mode 2 shown in FIG. 14, image is made to be ¼ of its original size by finely cutting out the image without reducing the image itself. In fact, with each line memory, only a quarter portion in the horizontal direction is cut out. For example, it is a state where image is cut along upper and lower lines and a part is cutout so that the horizontal length becomes ¼ of its original length. Here, the length in the vertical direction is the original length, and the number of pixels is ¼ of its original number. However, a position to be cut out is arbitrary and it is also possible to cutout a feature portion of an image that has already been image-recognized and appeared before one or more frames. For example, it is possible to cut out a portion containing a human face.

As a result, the image becomes smaller and the analysis range also becomes smaller, but the resolution becomes as high as that before cutting out. For example, it is possible to increase the precision of image recognition.

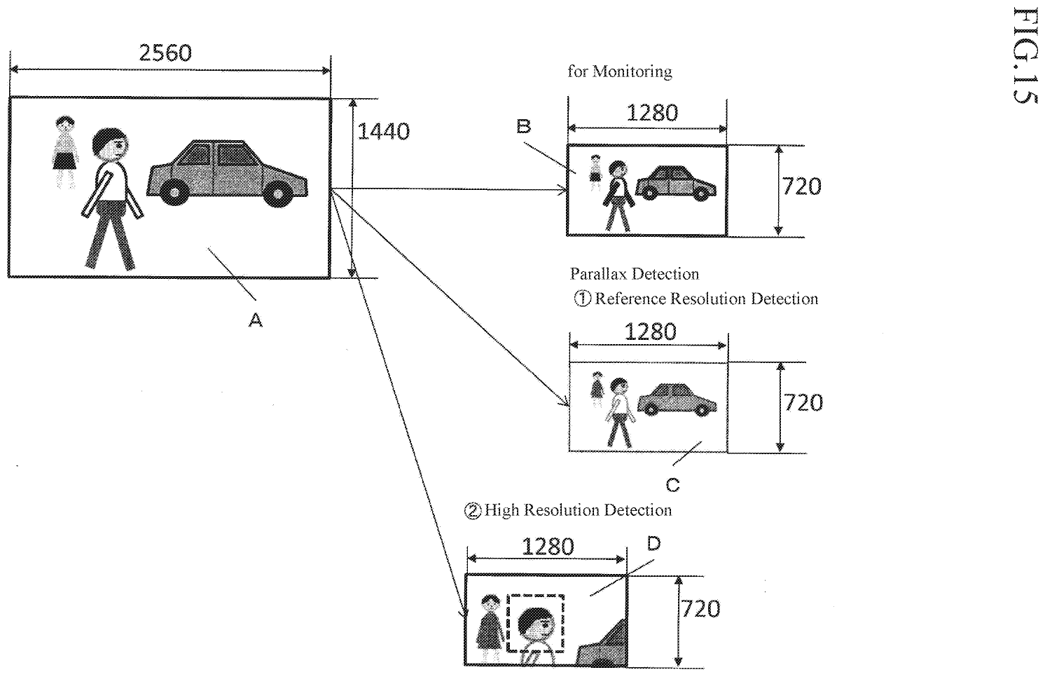

In such a stereo imaging device, as shown in FIG. 15, for example, two images are taken in synchronism, using a stereo camera having the first image sensor 1 and the second image sensor 2 which together include a high pixel count such as 2560×1440 of effective pixels, thus outputting an image signal A representing two moving images (here, only one moving image is shown). At this time, the stereo imaging device of the present embodiment outputs a monitoring signal and a parallax detection signal. Here, the monitoring signal is synchronized using the line memory unit 11 (as described above) and is used as luminance/color difference signal. Meanwhile, the vertical and horizontal pixel counts are reduced to ½ and the image signal B of the moving image data of 1280×720 pixels is outputted. In this way, it is possible to output the image signal to a usual monitor without requiring a high-definition monitor as a monitor for monitoring. On the other hand, the number of pixels of the monitoring signal may be selected from a plurality of preset numbers. Further, the output from the line memory unit 11 is also used to generate a parallax detection signal. In the parallax detection signal, no color is required in creating the distance image from the calculation of the parallax, and there is no need for synchronization and generation of the luminance/color difference signal or the like in the case of the above-mentioned monitoring signal, thus creating an image of the luminance signal as a parallax detection signal (image signal C) through a smoothing process. The parallax detection signal is also reduced, and the number of vertical and horizontal pixels is reduced to ½ and outputted as an image signal C of moving image data of 1280×720 pixels. The image size in the parallax detection signal is set according to, for example, the capability of the integrated circuit that performs the image processing. Here, the image recognition processing is, for example, performed outside the stereo imaging device. When performing the image recognition, it is possible to detect a human face photographed during face detection, and to detect a specific face by comparing a detected face with a stored face, and to collate the person with a number on the car license plate. Therefore, if it is desired to recognize a person's face in detail, it is possible to cut out a portion of the same number of pixels as a reduced image, to output the same as parallax detection signal, without reducing the image by designating a cutting range of the image. The image signal D of the image to be cut out is, for example, ¼ portion of the image in the horizontal direction on the line memory (as described above). When the original image is 2560×1440 pixels, ¼ of an image of 640×1440 pixels in only the horizontal direction is cut out.

The cut-out image is not reduced and has a high definition, but can be processed in the same manner as the reduced image signal C by cutting the image size to make it smaller. In the present embodiment, since the processing after the line memory unit 11 is divided into monitoring and parallax detection, even if the magnification of the image is changed or the frame rate is changed on the parallax detection side, the display magnification and frame rate of the monitor do not change, and monitoring is thus not affected. In other words, the current situation can be monitored in real time, and a specific target person such as a criminal can be detected by high-precision image recognition using the parallax of the stereo camera. On the other hand, in the parallax detection signal, the size of the cutout range maybe arbitrarily set, or may be selected from a plurality of preset sizes. Moreover, the reduction ratios of the parallax detection signal and the monitoring signal may be fixed, changed, or may be selected from a plurality of reduction ratios. However, when the reduction ratio is to be fixed, it is necessary for the parallax detection signal to be processed in one of the two ways, i.e., either being reduced or being finely cutout without being reduced.

In the above description, the synchronization process of the monitoring signal, the smoothing process of the parallax detection signal, and the decimation of the monitoring signal and the parallax detection signal are performed using the line memory. On the other hand, it is also possible to use frame memory instead of line memory in the above processes. In this case, the frame memory may be used for one frame or a plurality of frames. Using the frame memory it is possible to store the data of all the pixels of the frame. For example, in each pixel, it is possible to perform an interpolation processing or a smoothing process using the data of the surrounding pixels, and it is also possible to perform sub-sampling in the pixels arranged in vertical and horizontal directions. By using the frame memory, it is possible to store the values of all pixels for one frame of the image signals outputted from the image sensors 1, 2. Therefore, any known method can be used for interpolation, smoothing, and sub-sampling, thus increasing the degree of freedom in designing a stereo camera.

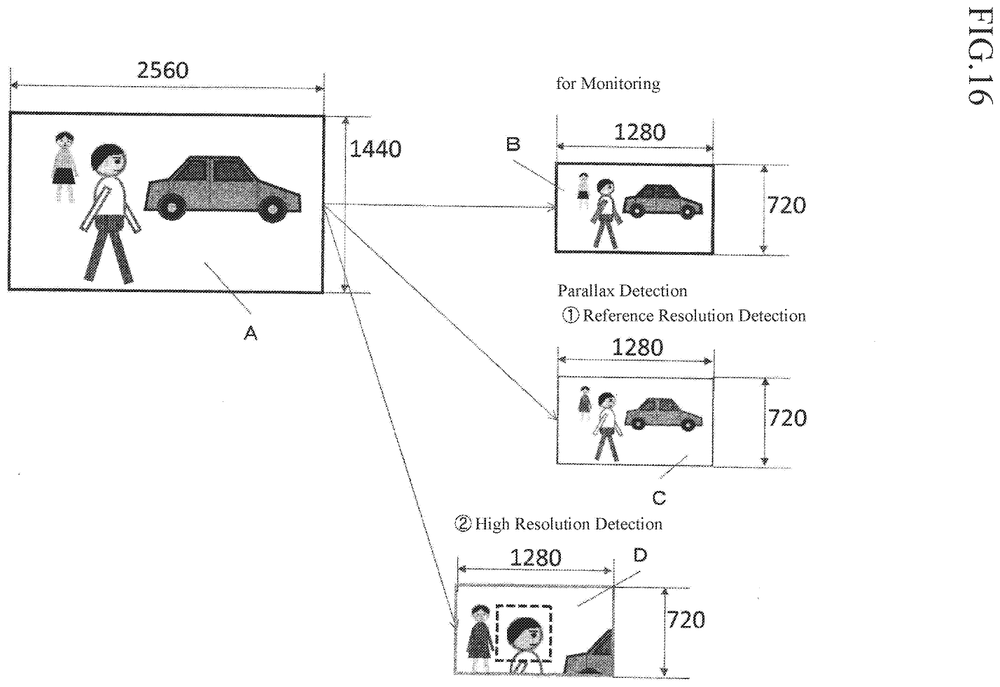

FIG. 16 illustrates the outputs of the monitoring signal and the parallax detection signal when the frame memory is used. Basically, similar to the line memory shown in FIG. 15, the monitoring signal and the parallax detection signal are generated, reduced and outputted. On the other hand, when cutting-out an image D using the line memory of FIG. 15, an image cut in the vertical direction is outputted. However, in the frame memory, it is easy to perform the cutting-out at any place in the vertical direction and the horizontal direction. Therefore, as shown in FIG. 16, when the number of pixels is reduced by cutting out the parallax detection signal without reducing the same and with the resolution being kept high, it is possible to perform the cutting-out in both the vertical direction and the horizontal direction, obtaining an image having the number of pixels of 1280×720. On the other hand, it is also possible to arbitrarily set the position and size of the cutting-out on the frame memory.

### EXPLANATION OF REFERENCE NUMERALS

1 first image sensor
2 second image sensor
4. unit for generating monitoring signal and parallax detection signal
5. parallax detection signal generating unit
11 line memory unit
14 first reduction processing circuit
16 second reduction processing circuit
21 first line memory
22 second line memory
71 horizontal/vertical sub-sampling circuit (line memory)

1. A stereo imaging device that outputs image signals captured by a stereo camera to a monitoring monitor and outputs the image signals to an image recognition unit that generates at least a distance image from a parallax of the image signals, the stereo imaging device comprising:
two image sensors for outputting the image signals;
parallax detection signal generating unit for generating two parallax detection signals for detecting a parallax from the two image signals;
monitoring signal generating unit for generating a monitoring signal to be outputted to the monitor, from an image signal fed from one of the two image sensors;
parallax detection signal reducing unit for reducing and outputting the parallax detection signals; and
monitoring signal reducing unit for reducing and outputting the monitoring signal.

2. The stereo imaging device according to claim 1, wherein
the parallax detection signal generating unit and the monitoring signal generating unit include two or more line memories, and perform a synchronization processing on the monitoring signal, and perform a smoothing processing on the parallax detection signals by using the line memories.

3. The stereo imaging device according to claim 1, wherein
each of the parallax detection signal reducing unit and the monitoring signal reducing unit includes a plurality of line memories, and performs sub-sampling using the line memories.

4. The stereo imaging device according to claim 1, wherein
the parallax detection signal generating unit and the monitoring signal generating unit include frame memory, and perform a synchronization processing on the monitoring signal, and perform a smoothing processing on the parallax detection signals by using the frame memory.

5. The stereo imaging device according to claim 1, wherein
each of the parallax detection signal reducing unit and the monitoring signal reducing unit includes frame memory, and reduces the parallax detection signals and the monitoring signal by using the frame memory.

6. The stereo imaging device according to claim 1, wherein
the parallax detection signal reducing unit is configured to cut out an image represented by a parallax detection signal, in a manner such that the image becomes smaller than its original size, thereby outputting the parallax detection signal in which the pixels of the image have been reduced.

7. The stereo imaging device according to claim 2, wherein
each of the parallax detection signal reducing unit and the monitoring signal reducing unit includes a plurality of line memories, and performs sub-sampling using the line memories.

8. The stereo imaging device according to claim 2, wherein
each of the parallax detection signal reducing unit and the monitoring signal reducing unit includes frame memory, and reduces the parallax detection signals and the monitoring signal by using the frame memory.

9. The stereo imaging device according claim 2, wherein
the parallax detection signal reducing unit is configured to cut out an image represented by a parallax detection signal, in a manner such that the image becomes smaller than its original size, thereby outputting the parallax detection signal in which the pixels of the image have been reduced.

10. The stereo imaging device according to claim 3, wherein
the parallax detection signal reducing unit is configured to cut out an image represented by a parallax detection signal, in a manner such that the image becomes smaller than its original size, thereby outputting the parallax detection signal in which the pixels of the image have been reduced.

11. The stereo imaging device according to claim 4, wherein
the parallax detection signal reducing unit is configured to cut out an image represented by a parallax detection signal, in a manner such that the image becomes smaller than its original size, thereby outputting the parallax detection signal in which the pixels of the image have been reduced.

12. The stereo imaging device according to claim 5, wherein
the parallax detection signal reducing unit is configured to cut out an image represented by a parallax detection signal, in a manner such that the image becomes smaller than its original size, thereby outputting the parallax detection signal in which the pixels of the image have been reduced.

13. The stereo imaging device according to claim 7, wherein
the parallax detection signal reducing unit is configured to cut out an image represented by a parallax detection signal, in a manner such that the image becomes smaller than its original size, thereby outputting the parallax detection signal in which the pixels of the image have been reduced.

14. The stereo imaging device according to claim 8, wherein
the parallax detection signal reducing unit is configured to cut out an image represented by a parallax detection signal, in a manner such that the image becomes smaller than its original size, thereby outputting the parallax detection signal in which the pixels of the image have been reduced.
